(19) United States
(12) Patent Application Publication
(10) Pub. No.: US 2014/0285659 A1
(43) Pub. Date: Sep. 25, 2014

(54) INTELLIGENT CENTRAL SURVEILLANCE SERVER SYSTEM AND CONTROLLING METHOD THEREOF

(71) Applicant: 4NSYS CO., LTD., Seoul (KR)

(72) Inventors: Hak Tae KIM, Seoul (KR); Jason CHAE, Seoul (KR); Jae Cheol LEE, Seoul (KR); Chang Rok KIM, Incheon (KR); Yeon Chul JUNG, Gwangmyeong-si (KR); Jung Ho HWANG, Seoul (KR)

(73) Assignee: 4NSYS Co., Ltd., Seoul (KR)

(21) Appl. No.: 13/867,920

(22) Filed: Apr. 22, 2013

(30) Foreign Application Priority Data
Mar. 19, 2013 (KR) 10-2013-0029028

(51) Int. Cl. H04N 7/18

(52) U.S. Cl. CPC H04N 7/183
USPC 348/143

(57) ABSTRACT

The present invention relates to an intelligent central surveillance server system and controlling method thereof, which are capable of determining whether or not a preset event occurs based on a sensor sense signal and/or a motion sense signal and transmitting/receiving image information obtained in the occurrence of event through a serve-client system. The intelligent central surveillance server system comprises: a sensor unit configured to sense and transmit a sense signal; a camera unit configured to pick and transmit video information; and a digital video transmitter configured to determine whether or not a preset event occurs, based on the sense signal and/or the video information, and transmit first video information and first list information related to the first video information on the basis of the point of occurrence of event when the preset event occurs.

### BACKGROUND OF THE INVENTION

1. Field of the Invention

The present invention relates to an intelligent central surveillance server system and controlling method thereof, and more particularly, to an intelligent central surveillance server system and controlling method thereof, which are capable of determining whether or not a preset event occurs based on a sensor sense signal and/or a motion sense signal and transmitting/receiving image information obtained in the occurrence of event through a serve-client system.

2. Description of the Related Art

In general, a central surveillance system comprises a server, such as a digital video recorder (DVR)/digital video transmitter (DVT) or the like, for storing videos picked by analog CCTV cameras, and one or more clients which are connected to the server for displaying videos transmitted from the server.

However, such a central surveillance system has a difficulty in allowing a remote operator corresponding to a client to control cameras connected to the DVR/DVT as the DVR/DVT acts as a server.

### RELATED TECHNICAL DOCUMENTS

### Patent Documents

Patent Document 1: Korean Patent Application No. 10-2004-0025909

### SUMMARY OF THE INVENTION

Accordingly, it is an object of the present invention to provide an intelligent central surveillance server system and controlling method thereof, which are capable of determining whether or not a preset event occurs based on a sensor sense signal and/or a motion sense signal and transmitting/receiving image information obtained in the occurrence of event through a serve-client system.

To achieve the above object, according to an aspect of the invention, there is provided an intelligent central surveillance server system comprising: a sensor unit configured to sense and transmit a sense signal; a camera unit configured to pick and transmit video information; and a digital video transmitter configured to determine whether or not a preset event occurs, based on the sense signal and/or the video information, and transmit first video information and first list information related to the first video information on the basis of the point of occurrence of event when the preset event occurs.

According to another aspect of the invention, there is provided a control method of an intelligent central surveillance server system comprising a digital video transmitter configured to determine whether or not a preset event occurs, an intelligent central surveillance server (ICSS) acting as a server, an intelligent central surveillance management (ICSM) and an intelligent central surveillance client (ICSC) acting as clients, comprising the steps of: receiving a sense signal which is sensed by and transmitted from a sensor unit, through the digital video transmitter; receiving video information which is transmitted from a camera unit, through the digital video transmitter; determining whether or not the preset event occurs, based on the received sense signal and/or video information, through the digital video transmitter; and, if it is determined that the preset event occurs, transmitting first video information and first list information related to the first video information on the basis of the point of occurrence of event, through the digital video transmitter.

The intelligent central surveillance server system and controlling method thereof according to the aspects of the invention are capable of determining whether or not a preset event occurs based on a sensor sense signal and/or a motion sense signal and transmitting/receiving image information obtained in the occurrence of event through a serve-client system, which may result in improved efficiency of the intelligent central surveillance server system.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a block diagram showing a configuration of an intelligent central surveillance server system in accordance with a first embodiment of the present invention;

FIG. 2 is a block diagram showing a configuration of an intelligent central surveillance server system in accordance with a second embodiment of the present invention;

FIG. 3 is a block diagram showing a configuration of an intelligent central surveillance server system in accordance with a third embodiment of the present invention;

FIG. 4 is a block diagram showing a configuration of an intelligent central surveillance server system in accordance with a fourth embodiment of the present invention;

FIG. 5 is a flowchart showing a control method of the intelligent central surveillance server system in accordance with the first embodiment;

FIG. 6 is a flowchart showing a control method of the intelligent central surveillance server system in accordance with the second embodiment;

FIG. 7 is a flowchart showing a control method of the intelligent central surveillance server system in accordance with the third embodiment; and

FIG. 8 is a flowchart showing a control method of the intelligent central surveillance server system in accordance with the fourth embodiment.

### DETAILED DESCRIPTION OF THE PREFERRED EMBODIMENT

It is to be noted that technical terms used in the specification are intended to describe specific embodiments but is not construed to limit the present invention. In addition, the technical terms used in the specification should be construed to have meanings understood by those skilled in the art, unless otherwise stated, without being construed to have unduly inclusive or exclusive meanings. In addition, it is to be understood that superficial technical terms, which may not correctly express the spirit of the invention, have to be replaced with technical terms which can be correctly understood by those skilled in the art. In addition, generic terms used in the specification should be construed according to dictionary definitions or according to the context, without being construed to have unduly exclusive meanings.

In addition, singular forms used in the specification are intended to include plural forms, unless otherwise stated. “Comprising”, “including” and variants thereof in the specification should not be construed to include all of various elements or steps described in the specification but they may exclude some of the elements or steps or may include additional elements or steps.

In addition, relational terms, such as “first”, “second” and the like, used in the specification are not intended to limit various elements, although they may be used to describe the elements. These terms are only used to distinguish one element from another. For example, a first element may be named a second element and vice versa, without departing from the spirit and scope of the invention.

Hereinafter, preferred embodiments of the present invention will be described in detail with reference to the accompanying drawings. In the embodiments, same or similar elements are denoted by the same reference numerals and explanation of which will be not repeated.

In the following detailed description of the present invention, concrete description on related functions or constructions will be omitted if it is deemed that the functions and/or constructions may unnecessarily obscure the gist of the present invention. In addition, it is be noted that the accompanying drawings are only provided to allow the readers to easily understood the ideas of the invention but should not be construed to limit the spirit and scope of the invention.

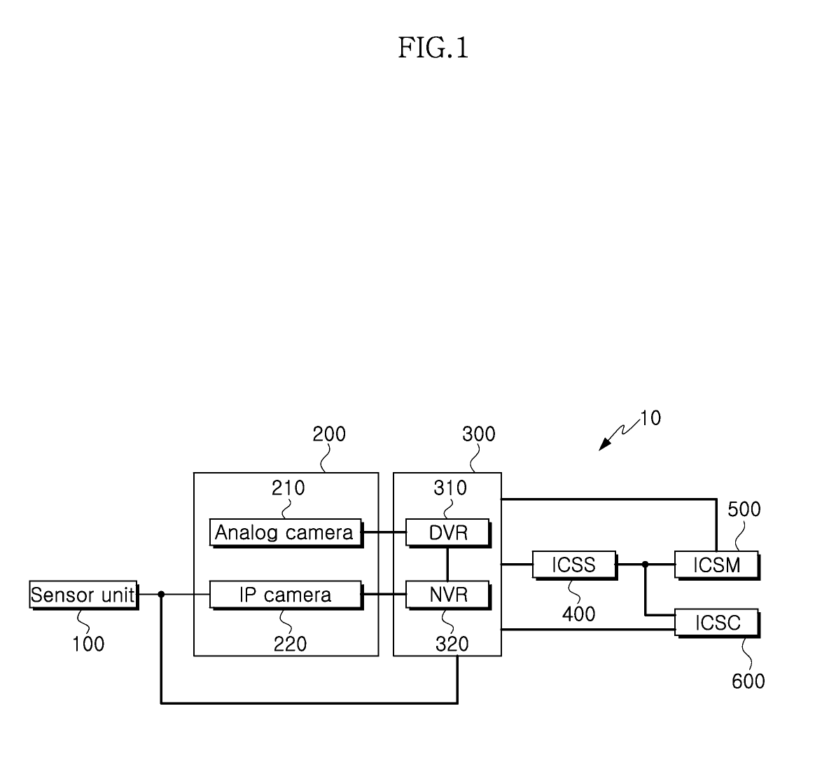

FIG. 1 is a block diagram showing a configuration of an intelligent central surveillance server system 10 in accordance with a first embodiment of the present invention.

Referring to FIG. 1, an intelligent central surveillance server system 10 comprises a censor unit 100, a camera unit 200, a digital video transmitter 300, an intelligent central surveillance server (ICSS) 400, an intelligent central surveillance management (ICSM) 500 and an intelligent central surveillance client (ICSC) 600. All elements of the intelligent central surveillance server system 10 shown in FIG. 1 are not essential but the intelligent central surveillance server system 10 may be implemented with fewer or more elements.

The sensor unit 100 is provided at a specified location of the intelligent central surveillance server system 10 and performs a sensing function for an area where the sensor unit 100 is located, at preset time intervals, random time intervals, or in real time.

In addition, the sensor unit 100 senses any contact signal (for example, an ON/OFF signal or a 0/1 signal).

The sensor unit 100 comprises a motion recognition sensor for sensing motion and position of an object, a sensor for sensing ON/OFF of a door, a thermal sensor for sensing heat (or temperature) of the object, etc. The motion recognition sensor may comprise a geomagnetism sensor, an acceleration sensor, a gyro sensor, an inertial sensor, an altimeter, a vibration sensor, any other sensors related to motion recognition, and so on.

The sensor unit 100 transmits the sensed signal to the digital video transmitter 300 and/or an IP camera 220 included in the camera unit 200.

As shown in FIG. 1, the camera unit 200 includes an analog camera 210 and the IP camera 220.

The analog camera 210 picks video information (or video data) on an area (or region) where the intelligent central surveillance server system 10 or the analog camera 210 is installed. The analog camera 210 processes a frame of a still image or a video obtained from an image sensor (or a camera module/CCD sensor module). That is, the analog camera 210 encodes the picked video information based on a preset codec system or the like.

In addition, the analog camera 210 transmits the picked video information (or the encoded video information or the encoded digital video information), along with an ID (Identification) of the analog camera 210 and so on, to the digital video transmitter 300 in a wired/wireless manner. Here, the picked video information may include date/time, codec information in addition to video information.

The IP camera 220 picks video information on an area/region where it is installed. The IP camera 220 is called a network camera or a digital CCTV and supports a resolution of a HD class (1280×720), a full HD class (1920×1080), a 5 mega class (2560×2048) or the like.

The IP camera 220 encodes the picked video information based on a preset codec system or the like.

The IP camera 220 transmits the picked video information (or the encoded video information or the encoded digital video information), along with an ID (Identification) of the IP camera 220 and so on, to the digital video transmitter 300 in a wired/wireless manner.

The IP camera 220 receives the sensed signal from the sensor unit 100.

The IP camera 220 performs a video analysis function for the received sensed signal.

The IP camera 220 transmits a result of the performance of the video analysis function to the digital video transmitter 300.

The analog camera 210 and the IP camera 220 perform their respective PTZ (Pan, Tilt and Zoom) functions based on a control signal transmitted from the ICSM 500.

The analog camera 210 and the IP camera 220 transmit a result of the control of the PTZ function to the ICSM 500 via the digital video transmitter 300 and the ICSS 400.

The digital video transmitter 300 receives the sensed signal transmitted from the sensor unit 100.

The digital video transmitter 300 receives the video information transmitted from the camera unit 200.

The digital video transmitter 300 includes a digital video recorder (DVR) 310 and a network video recorder (NVR) 320, as shown in FIG. 1.

The DVR 310 receives video information from the analog camera 210.

The DVR (or a digital video transmitter (DVT)) 310 is connected to the NVR 320.

The NVR 320 receives the video signal from the IP camera 220.

The DVR 310 and the NVR 320 are also interconnected to the sensor unit 100 for receiving the sensed signal from the sensor unit 100.

The digital video transmitter 300 determines whether or not a preset event occurs, based on the received sensed signal and/or video information.

That is, the digital video transmitter 300 determines whether or not a preset event occurs, such as sensing of object's motion, sensing of door ON/OFF and sensing of heat, based on the received sensed signal.

In addition, the digital video transmitter 300 determines whether or not a preset event occurs, such as sensing of object's motion, based on the received video information. That is, the digital video transmitter 300 detects a variation of values of pixels included in the received video information and immediately previously received video information to make determination on object's motion, based on the detected variation of values of pixels.

In addition, the digital video transmitter 300 detects a signal related to the presence of malfunction of the camera unit 200, such as camera loss (or video signal disconnection or the like) for the video information transmitted from the camera unit 200. Herein, the presence of malfunction of the camera unit 200 is included in the preset event.

In addition, if it is determined that the preset event occurs, the digital video transmitter 300 stores first video information on the basis of the point of event occurrence, and transmits it to the ICSS 400 in a wired/wireless manner. Here, the first video information includes the preset number of previous video information (for example, video information of at least two frames) on the basis of the point of event occurrence, current video information, and the preset number of posterior video information (for example, video information of at least seven frames). At this time, the digital video transmitter 300 transmits the first video information, along with first list information and so on, to the ICSS 400. Here, the first list information includes a representative still cut (or representative image) related to the first video information, an ID of the camera unit 200 picked the first video information, and information on the point of event occurrence.

As a result of the determination (or a result of sensing of the object's motion), when the object's motion included in the preset event is sensed, the digital video transmitter 300 stores the first video information on the basis of the point of sensing of the motion (or the point of event occurrence), and transmits it to the ICSS 400 in a wired/wireless manner. Here, the first video information includes the preset number of previous video information (for example, video information of at least two frames) on the basis of the point of sensing of the motion (or the point of event occurrence), current video information, and the preset number of posterior video information (for example, video information of at least seven frames) after the point of sensing of the motion (or the point of event occurrence).

In addition, as a result of sensing of the signal related to the presence of malfunction of the camera unit 200, when the signal related to the presence of malfunction of the camera unit 200 is sensed, the digital video transmitter 300 stores the first video information on the basis of the point of sensing of the signal (or the point of event occurrence), and transmits it to the ICSS 400 in a wired/wireless manner. Here, the first video information includes the preset number of previous video information (for example, video information of at least, two frames) on the basis of the point of sensing of the signal (or the point of event occurrence), current video information, and the preset number of posterior video information (for example, video information of at least seven frames) after the point of sensing of the signal (or the point of event occurrence).

The ICSS 400 receives the first video information and the first list information transmitted from the digital video transmitter 300 in the event occurrence.

The ICSS 400 displays and stores the received first video information and first list information.

The ICSS 400 transmits the received first video information and first list information to the ICSM 500 and/or at least one ICSC 600 in a wired/wireless manner.

The ICSM 500 receives the first video information and first list information transmitted from the ICSS 400.

Based on the received first video information and first list information, the ICSM 500 performs a management and/or setting function of the ICSS 400, a display and storage function of the received first video information and/or first list information, an information management function of a client and/or equipment (including, for example, the sensor unit 100, the camera unit 200, and the DVR 310 and/or NVR 320 contained in the digital video transmitter 300), a network transfer mode setting function, a confirmation function of video information selected by an operator from the first list information (or a playback function of the video information), an event processing function, a real-time video inquiry function through the equipment (including, for example, video inquiry, PTZ of the camera unit 200, top/bottom/left/right movement of the camera unit 200, video upsizing/downsizing, perspective, etc.), a video inquiry function or a speech recording function at the point of event occurrence through the equipment, a SMS forwarding function and/or an e-mail forwarding function to forward the first list information to a pre-registered terminal number and/or an e-mail address, and a load balance function (or a bypass function).

Here, the client information management function is a function to manage information such as a client's ID, password, name, contact, e-mail address, physical address and so on related to an equipment manager. The equipment information management function is a function to manage information such as a equipment number, client ID, registered log-in ID, registered log-in password, port number, equipment type, IP address, equipment information (including, for example, running of only two of four channels, mounting of two hard disks, etc.), equipment installation site, zone (or channel) event alias setting, and so on, related to the DVR 310 and/or NVR 320 contained in the digital video transmitter 300.

Since information received by a first ICSC cannot be processed in the absence of a manager/operator of the first ICSC, the load balance function (or bypass function) is responsible for passing an authority to a second ICSC.

As one example, under a situation where a manager of the first ICSC has a signal processing authority whereas a manager of the second ICSC has no signal processing authority, if the load balance function is set in the second ICSC, information received by the first ICSC is automatically transferred to the second ICSC and the manager of the second ICSC can manage the transferred information.

In addition, the intelligent central surveillance server system 10 may further include a microphone (not shown) for the speech recording function.

The ICSM 500 is in interaction with the digital video transmitter 300.

The ICSC 600 also receives the first video information and first list information transmitted from the ICSS 400.

Based on the received first video information and first list information, the ICSC 600 performs a display and storage function of the received first video information and/or first list information, an information management function of a client and/or equipment (including, for example, the sensor unit 100, the camera unit 200, and the DVR 310 and/or NVR 320 contained in the digital video transmitter 300), a network transfer mode setting function, a confirmation function of video information selected by an operator from the first list information (or a playback function of the video information), an event processing function, a real-time video inquiry function through the equipment (including, for example, video inquiry, PTZ of the camera unit 200, top/bottom/left/right movement of the camera unit 200, video upsizing/downsizing, perspective, etc.), a video inquiry function or a speech recording function at the point of event occurrence through the equipment, a SMS forwarding function and/or an e-mail forwarding function to forward the first list information to a pre-registered terminal number and/or an e-mail address, and a load balance function (or a bypass function).

The ICSC 600 may be formed in plural.

The ICSC 600 is in interaction with the digital video transmitter 300.

In this manner, the ICSS 400 acts as a server and the ICSM 500 and the ICSC 600 act as clients.

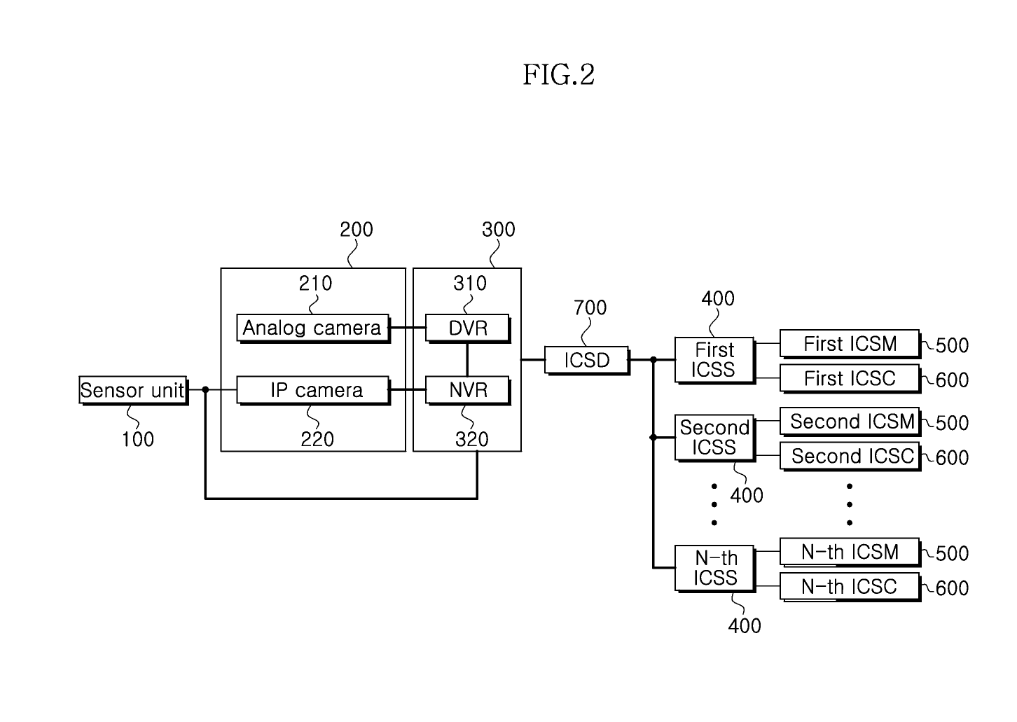

FIG. 2 is a block diagram showing a configuration of an intelligent central surveillance server system 10 in accordance with a second embodiment of the present invention.

Referring to FIG. 2, an intelligent central surveillance server system 10 includes a censor unit 100, a camera unit 200, a digital video transmitter 300, an intelligent central surveillance server (ICSS) 400, an intelligent central surveillance management (ICSM) 500, an intelligent central surveillance client (ICSC) 600 and an intelligent central surveillance daemon (ICSD) 700. All elements of the intelligent central surveillance server system 10 shown in FIG. 2 are not essential but the intelligent central surveillance server system 10 may be implemented with fewer or more elements.

The digital video transmitter 300 determines whether or not a preset event occurs, based on a sensed signal transmitted from the sensor unit 100 and/or video information transmitted from the camera unit 200.

In addition, if it is determined that the preset event occurs, the digital video transmitter 300 stores first video information on the basis of the point of event occurrence, and transmits it to the ICSD 700 in a wired/wireless manner.

As a result of the determination (or a result of sensing of the object's motion), when the object's motion included in the preset event is sensed, the digital video transmitter 300 stores the first video information on the basis of the point of sensing of the motion (or the point of event occurrence), and transmits it to the ICSD 700 in a wired/wireless manner.

In addition, as a result of sensing of the signal related to the presence of malfunction of the camera unit 200, when the signal related to the presence of malfunction of the camera unit 200 is sensed, the digital video transmitter 300 stores the first video information on the basis of the point of sensing of the signal (or the point of event occurrence), and transmits it to the ICSD 700 in a wired/wireless manner.

The ICSD 700 receives the first video information and the first list information transmitted from the digital video transmitter 300 in the event occurrence.

The ICSD 700 manages and/or stores a port number for communication connection with the digital video transmitter 300, event concurrent processing information, and ICSS 400 concurrent connection information (including, for example, IP address, port number, etc.)

The ICSD 700 can share the managed information (including, for example, the port number, the event concurrent processing information and the ICSS concurrent connection information) with the digital video transmitter 300 and/or the ICSS 400.

The ICSD 700 transmits the received first video information and the first list information to a plurality of pre-registered ICSSs 400 (for example, first ICSS, second ICSS, third ICSS and fourth ICSS).

The plurality of ICSSs 400 receives the first video information and the first list information transmitted from the ICSD 700.

Each of the plurality of ICSSs 400 displays and stores the received first video information and first list information.

In addition, each of the plurality of ICSSs 400 transmits the received first video information and first list information to the ICSM 500 and/or at least one ICSC 600 in communication with the plurality of ICSSs 400.

In this manner, the ICSSs 400 and the ICSD 700 act as servers and the ICSM 500 and the ICSC 600 act as clients.

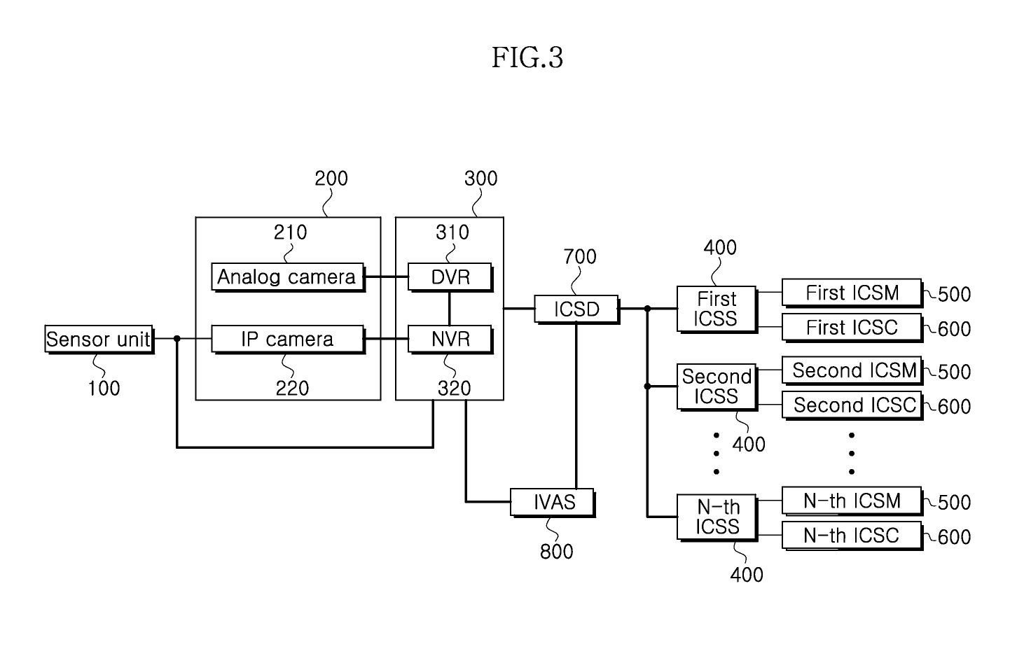

FIG. 3 is a block diagram showing a configuration of an intelligent central surveillance server system 10 in accordance with a third embodiment of the present invention.

Referring to FIG. 3, an intelligent central surveillance server system 10 includes a censor unit 100, a camera unit 200, a digital video transmitter 300, an intelligent central surveillance server (ICSS) 400, an intelligent central surveillance management (ICSM) 500, an intelligent central surveillance client (ICSC) 600, an intelligent central surveillance daemon (ICSD) 700 and an intelligent video analog system (IVAS) 800. All elements of the intelligent central surveillance server system 10 shown in FIG. 3 are not essential but the intelligent central surveillance server system 10 may be implemented with fewer or more elements.

If it is determined that a preset event occurs, the digital video transmitter 300 stores first video information on the basis of the point of event occurrence, and transmits it to the ICSD 700 and the IVAS 800 in a wired/wireless manner, as shown in FIG. 2.

As a result of the determination (or a result of sensing of the object's motion), when the object's motion included in the preset event is sensed, the digital video transmitter 300 stores the first video information on the basis of the point of sensing of the motion (or the point of event occurrence), and transmits it to the ICSD 700 and the IVAS 800 in a wired/wireless manner.

In addition, as a result of sensing of the signal related to the presence of malfunction of the camera unit 200, when the signal related to the presence of malfunction of the camera unit 200 is sensed, the digital video transmitter 300 stores the first video information on the basis of the point of sensing of the signal (or the point of event occurrence), and transmits it to the ICSD 700 and the IVAS 800 in a wired/wireless manner.

The IVAS 800 receives the first video information and the first list information transmitted from the digital video transmitter 300 in the event occurrence.

The IVAS 800 analyzes the received first video information. Based on a result of the analysis on the first video information, if a preset intelligent video event is sensed, the IVAS 800 stores second video information on the basis of the point of sensing of the intelligent video event, and transmits it to the ICSD 700. Here, the second video information includes the preset number of previous video information (for example, video information of at least two frames) on the basis of the point of sensing of the intelligent video event, current video information, and the preset number of posterior video information (for example, video information of at least seven frames) after the point of sensing of the intelligent video event. At this time, the IVAS 800 transmits the second video information, along with second list information and, so on, to the ICSD 700. Here, the second list information includes a representative still cut (or representative image) related to the second video information, an ID of the camera unit 200 picked the second video information, information on the point of sensing of the intelligent video event, and information on the intelligent video event. The intelligent video event includes trespass (or any object's trespass), wandering (or the object's wandering), backward, boundary trespass, object disappearing, object appearing, and camera occlusion (or scene switching/change).

The ICSD 700 receives the first video information and the first list information transmitted from the digital video transmitter 300 in the occurrence of event.

The ICSD 700 receives the second video information and the second list information transmitted from the IVAS 800 in the sensing of the intelligent video event.

The ICSD 700 transmits the received first video information and first list information to a plurality of pre-registered ICSSs 400 (for example, first ICSS, second ICSS, third ICSS and fourth ICSS).

The ICSD 700 transmits the received second video information and second list information to the plurality of pre-registered ICSSs 400.

The plurality of ICSSs 400 receives the first video information and the first list information transmitted from the ICSD 700.

The plurality of ICSSs 400 receives the second video information and the second list information transmitted from the ICSD 700.

Each of the plurality of ICSSs 400 displays and stores the received first video information, first list information, second video information and second list information.

In addition, each of the plurality of ICSSs 400 transmits the received first video information, first list information, second video information and second list information to the ICSM 500 and/or at least one ICSC 600 in communication with the plurality of ICSSs 400.

The ICSM 500 receives one or more of the first video information, first list information, second video information and second list information transmitted from the ICSSs 400.

Based on the received first video information, first list information, second video information and second list information, the ICSM 500 performs a management and/or setting function of the ICSS 400, a display and storage function of the received first video information, first list information, second video information and second list information, an information management function of a client and/or equipment, a network transfer mode setting function, a confirmation function of video information selected by an operator from the first or second list information (or a playback function of the video information), an event processing function, a real-time video inquiry function through the equipment, a video inquiry function or a speech recording function at the point of event occurrence or the point of intelligent video event sensing through the equipment, a SMS forwarding function and/or an e-mail forwarding function to forward the first list information and/or the second list information to a pre-registered terminal number and/or e-mail address, and a load balance function (or a bypass function).

The ICSC 600 receives one or more of the first video information, first list information, second video information and second list information transmitted from the ICSSs 400.

Based on the received first video information, first list information, second video information and second list information, the ICSC 600 performs a display and storage function of the received first video information, first list information, second video information and second list information, an information management function of a client and/or equipment, a network transfer mode setting function, a confirmation function of video information selected by an operator from the first or second list information (or a playback function of the video information), an event processing function, a real-time video inquiry function through the equipment, a video inquiry function or a speech recording function at the point of event occurrence or the point of intelligent video event sensing through the equipment, a SMS forwarding function and/or an e-mail forwarding function to forward the first list information and/or the second list information to a pre-registered terminal number and/or e-mail address, and a load balance function (or a bypass function).

In this manner, the ICSSs 400, the ICSD 700 and the IVAS 800 act as servers and the ICSM 500 and the ICSC 600 act as clients.

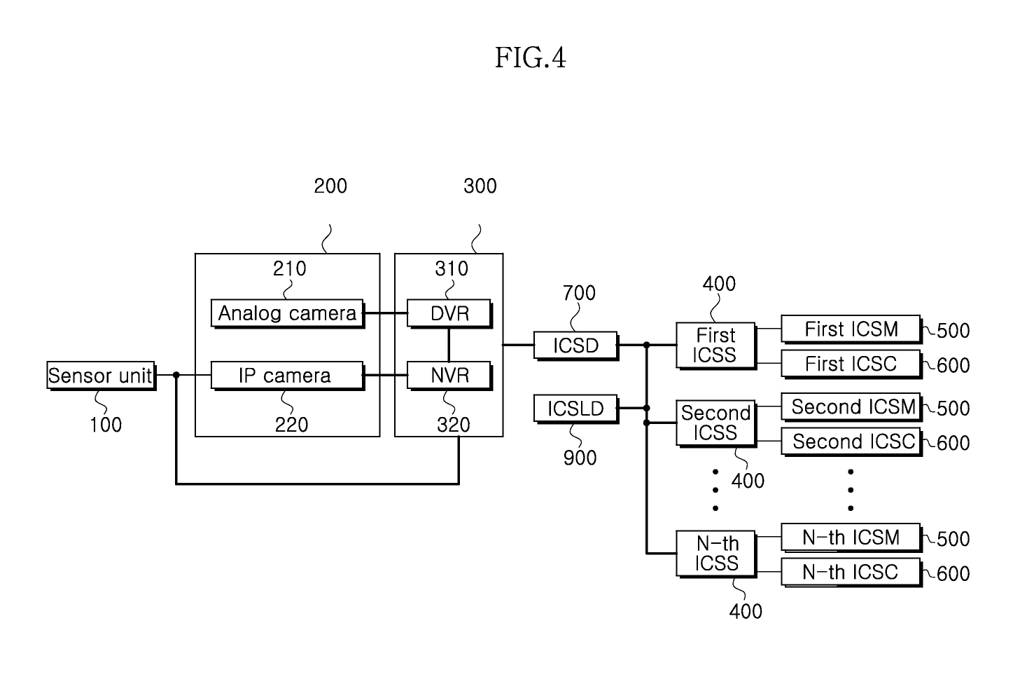

FIG. 4 is a block diagram showing a configuration of an intelligent central surveillance server system 10 in accordance with a fourth embodiment of the present invention.

Referring to FIG. 4, an intelligent central surveillance server system 10 includes a censor unit 100, a camera unit 200, a digital video transmitter 300, an intelligent central surveillance server (ICSS) 400, an intelligent central surveillance management (ICSM) 500, an intelligent central surveillance client (ICSC) 600, an intelligent central surveillance daemon (ICSD) 700 and an intelligent central surveillance license plate daemon (ICSLD) 900. All elements of the intelligent central surveillance server system 10 shown in FIG. 4 are not essential but the intelligent central surveillance server system 10 may be implemented with fewer or more elements.

If a preset event occurs, the ICSD 700 receives first video information and first list information transmitted from the digital video transmitter 300, as shown in FIG. 2.

The ICSD 700 transmits the received first video information and first list information to a plurality of pre-registered ICSSs 400 (for example, first ICSS, second ICSS, third ICSS and fourth ICSS) and the ICSLD 900.

In response to the first video information and first list information transmitted to the ICSLD 900, the ICSD 700 receives a result of performance of car license plate recognition function, which is transmitted from the ICSLD 900. When the ICSD 700 receives the result of performance of car license plate recognition function, which is transmitted from the ICSLD 900, the ICSD 700 transmits the received result of performance of car license plate recognition function to the plurality of ICSSs 400.

Each of the plurality of ICSSs 400 receives the first video information and the first list information transmitted from the ICSD 700.

In addition, each of the plurality of ICSSs 400 transmits the received first video information and first list information to the ICSM 500, at least one ICSC 600 and the ICSLD 900 in communication with the plurality of ICSSs 400.

In response to the first video information and first list information transmitted to the ICSLD 900, each of the plurality of ICSS 400 receives the result of performance of car license plate recognition function, which is transmitted from the ICSLD 900.

Each of the plurality of ICSS 400 may receive the result of performance of car license plate recognition function, which is transmitted from the ICSD 700.

Each of the plurality of ICSS 400 displays and stores the received result of performance of car license plate recognition function.

Each of the plurality of ICSSs 400 transmits the received result of performance of car license plate recognition function to the ICSM 500 and/or at least one ICSC 600 in communication with the plurality of ICSSs 400.

The ICSLD 900 receives the first video information and first list information transmitted from the ICSD 700 and/or the plurality of ICSSs 400.

The ICSLD 900 performs the car license plate recognition function based on the received first video information. Here, the car license plate recognition function includes a car license plate recognition function related to any car image contained in the received first video information, a wanted car determination function for the recognized car license plate, etc.

The ICSLD 900 transmits the result of performance of the car license plate license recognition function to the ICSD 700 and/or the plurality of ICSSs 400. Here, the result of performance of the car license plate license recognition function includes information on the recognized car license plate related to any car, information on wanted car determination for the recognized car license plate, etc.

The ICSLD 900 may perform the car license plate recognition function for video information (for example, any past/current video information) transmitted from the digital video transmitter 300, and transmit the result of performance of the car license plate recognition function to the ICSD 700 and/or the plurality of ICSSs 400.

The ICSM 500 receives the first video information, the first list information, and the result of performance of the car license plate recognition function transmitted from the ICSSs 400.

The ICSM 500 displays and/or stores the received result of performance of the car license plate recognition function.

The ICSC 600 receives the first video information, the first list information, and the result of performance of the car license plate recognition function transmitted from the ICSSs 400.

The ICSC 600 displays and/or stores the received result of performance of the car license plate recognition function.

In this manner, the ICSSs 400, the ICSD 700 and the ICSLD 900 act as servers and the ICSM 500 and the ICSC 600 act as clients.

In addition, by determining whether or not a preset event occurs based on a sensor sensing signal and/or a motion sensing signal, video information picked in the occurrence of event can be transmitted/received through a server-client system.

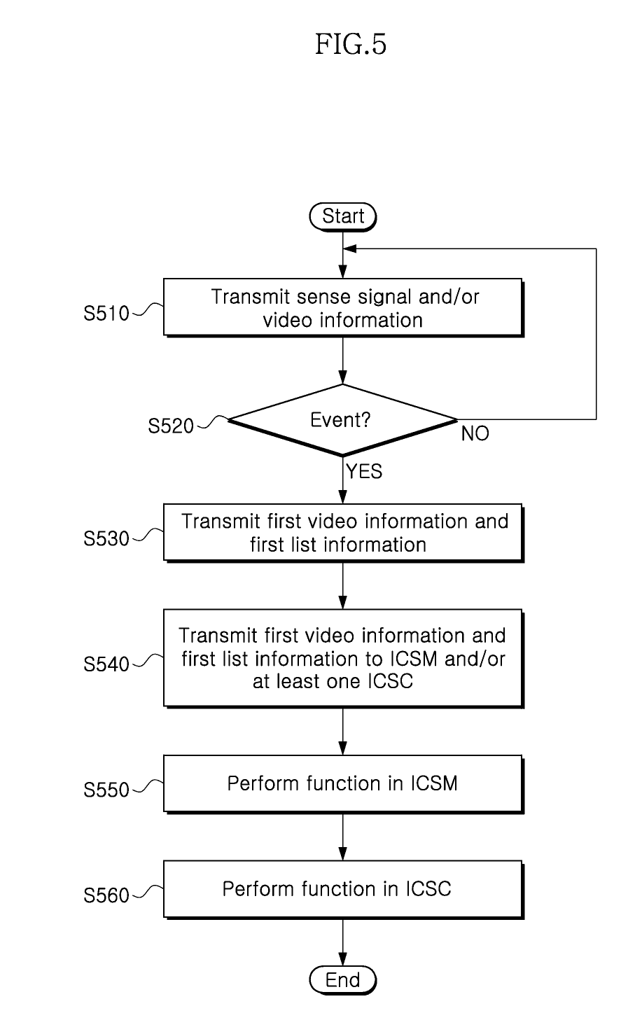

FIG. 5 is a flow chart showing a control method of the intelligent central surveillance server system in accordance with the first embodiment of the present invention.

First, the sensor unit 100 transmits a sensed signal to the digital video transmitter 300 at preset time intervals, random time intervals, or in real time. Here, the sensed signal from the sensor unit 100 includes any contact signal (for example, an ON/OFF signal or a 0/1 signal), an ID of the sensor unit 100, etc.

The camera unit 200 transmits video information picked in an area (or region) where the camera unit 200 is installed, and an ID of the camera unit 200 to the digital video transmitter 300 (S510).

Thereafter, the digital video transmitter 300 receives the sensed signal from the sensor unit 100 and/or the video information from the camera unit 200.

The digital video transmitter 300 determines whether or not a preset event occurs, based on the received sensed signal and/or video information.

That is, the digital video transmitter 300 determines whether or not a preset event occurs, such as sensing of object's motion, sensing of door ON/OFF and sensing of heat, based on the received sensed signal.

In addition, the digital video transmitter 300 determines whether or not a preset event occurs, such as sensing of object's motion, based on the received video information. That is, the digital video transmitter 300 detects a variation of values of pixels included in the received video information and immediately previously received video information to make determination on object's motion, based on the detected variation of values of pixels.

In addition, the digital video transmitter 300 detects a signal related to the presence of malfunction of the camera unit 200, such as camera loss (or video signal disconnection or the like) for the video information transmitted from the camera unit 200 (S520).

Thereafter, if it is determined that the preset event occurs, the digital video transmitter 300 stores first video information on the basis of the point of event occurrence, and transmits it to the ICSS 400 in a wired/wireless manner. Here, the first video information includes the preset number of previous video information (for example, video information of at least two frames) on the basis of the point of event occurrence, current video information, and the preset number of posterior video information (for example, video information of at least seven frames). At this time, the digital video transmitter 300 transmits the first video information, along with first list information and so on, to the ICSS 400. Here, the first list information includes a representative still cut (or representative image) related to the first video information, an ID of the camera unit 200 picked the first video information, and information on the point of event occurrence.

As a result of the determination (or a result of sensing of the object's motion), when the object's motion included in the preset event is sensed, the digital video transmitter 300 stores the first video information on the basis of the point of sensing of the motion (or the point of event occurrence), and transmits it to the ICSS 400 in a wired/wireless manner. Here, the first video information includes the preset number of previous video information (for example, video information of at least two frames) on the basis of the point of sensing of the motion (or the point of event occurrence), current video information, and the preset number of posterior video information (for example, video information of at least seven frames) after the point of sensing of the motion (or the point of event occurrence).

In addition, as a result of sensing of the signal related to the presence of malfunction of the camera unit 200, when the signal related to the presence of malfunction of the camera unit 200 is sensed, the digital video transmitter 300 stores the first video information on the basis of the point of sensing of the signal (or the point of event occurrence), and transmits it to the ICSS 400 in a wired/wireless manner. Here, the first video information includes the preset number of previous video information (for example, video information of at least two frames) on the basis of the point of sensing of the signal (or the point of event occurrence), current video information, and the preset number of posterior video information (for example, video information of at least seven frames) after the point of sensing of the signal (or the point of event occurrence) (S530).

Thereafter, the ICSS 400 receives the first video information and the first list information transmitted from the digital video transmitter 300 in the event occurrence. Here, the first list information includes a representative still cut (or representative image) related to the first video information, an ID of the camera unit 200 picked the first video information, and information on the point of event occurrence.

The ICSS 400 displays and stores the received first video information and first list information.

The ICSS 400 transmits the received first video information and first list information to the ICSM 500 and/or at least one ICSC 600 in a wired/wireless manner.

In this manner, the ICSS 400 performs the functions of displaying, storing and transmitting the first video information and the first list information transmitted from the digital video transmitter 300 in the occurrence of event (S540).

Thereafter, the ICSM 500 receives the first video information and first list information transmitted from the ICSS 400.

Based on the received first video information and first list information, the ICSM 500 performs a management and/or setting function of the ICSS 400, a display and storage function of the received first video information and/or first list information, an information management function of a client and/or equipment (including, for example, the sensor unit 100, the camera unit 200, and the DVR 310 and/or NVR 320 contained in the digital video transmitter 300), a network transfer mode setting function, a confirmation function of video information selected by an operator from the first list information (or a playback function of the video information), an event processing function, a real-time video inquiry function through the equipment (including, for example, video inquiry, PTZ of the camera unit 200, top/bottom/left/right movement of the camera unit 200, video upsizing/downsizing, perspective, etc.), a video inquiry function or a speech recording function at the point of event occurrence through the equipment, a SMS forwarding function and/or an e-mail forwarding function to forward the first list information to a pre-registered terminal number and/or an e-mail address, and a load balance function (or a bypass function).

That is, based on the received first video information and first list information, the ICSM 500 performs the plurality of functions of the ICSM 600 and the management and/or setting function of the ICSS 400, which is a unique function of the ICSM 500 (S550).

Thereafter, the ICSC 600 receives the first video information and first list information transmitted from the ICSS 400.

Based on the received first video information and first list information, the ICSC 600 performs various functions including a display and storage function of the received first video information and first list information, an information management function of a client and/or equipment (including, for example, the sensor unit 100, the camera unit 200, and the DVR 310 and/or NVR 320 contained in the digital video transmitter 300), a network transfer mode setting function, a confirmation function of video information selected by an operator from the first list information (or a playback function of the video information), an event processing function, a real-time video inquiry function through the equipment (including, for example, video inquiry, PTZ of the camera unit 200, top/bottom/left/right movement of the camera unit 200, video upsizing/downsizing, perspective, etc.), a video inquiry function or a speech recording function at the point of event occurrence through the equipment, a SMS forwarding function and/or an e-mail forwarding function to forward the first list information to a pre-registered terminal number and/or an e-mail address, and a load balance function (or a bypass function) (S560).

In this manner, the ICSS 400 acts as a server and the ICSM 500 and the ICSC 600 act as clients.

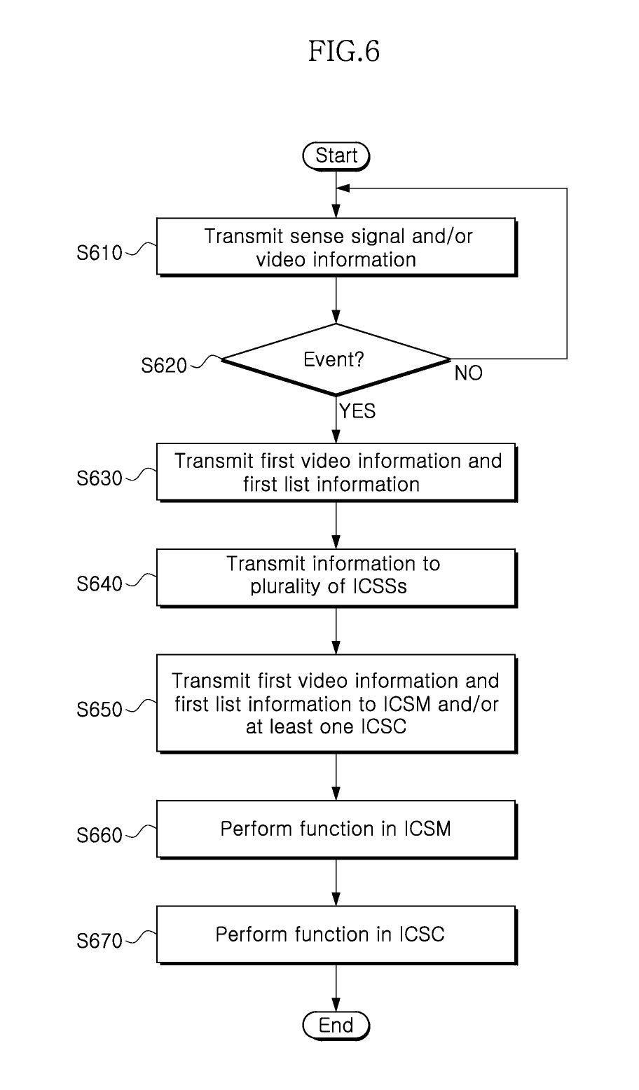

FIG. 6 is a flow chart showing a control method of the intelligent central surveillance server system in accordance with the second embodiment of the present invention.

First, the sensor unit 100 transmits a sensed signal to the digital video transmitter 300 at preset time intervals, random time intervals, or in real time.

The camera unit 200 transmits video information picked in an area (or region) where the camera unit 200 is installed, and an ID of the camera unit 200 to the digital video transmitter 300 (S610).

Thereafter, the digital video transmitter 300 receives the sensed signal from the sensor unit 100 and/or the video information from the camera unit 200.

The digital video transmitter 300 determines whether or not a preset event occurs, based on the received sensed signal and/or video information.

That is, the digital video transmitter 300 determines whether or not a preset event occurs, such as sensing of object's motion, sensing of door ON/OFF and sensing of heat, based on the received sensed signal, such as sensing of object's motion, based on the received video information, and such as camera loss (or video signal disconnection or the like) for the video information transmitted from the camera unit 200 (S620).

Thereafter, if it is determined that the preset event occurs, the digital video transmitter 300 stores first video information on the basis of the point of event occurrence, and transmits it to the ICSD 700 in a wired/wireless manner (S630).

Thereafter, the ICSD 700 receives the first video information and the first list information transmitted from the digital video transmitter 300 in the event occurrence.

The ICSD 700 transmits the received first video information and first list information to a plurality of ICSSs 400 (for example, first ICSS, second ICSS, third ICSS and fourth ICSS).

In this manner, as the ICSD 700 performs a data duplication transmission function (or back-up function) to transmit the first video information and the first list information from the digital video transmitter 300 to the plurality of ICSSs 400 in the occurrence of event, even if any ICSS 400 cannot receive the first video information and first list information due to any error/abnormality/fault, a different ICSS 400 having a back-up capability can receive the first video information and first list information (S640).

Thereafter, each of the plurality of ICSSs 400 receives the first video information and first list information transmitted from the ICSD 700.

Each of the plurality of ICSSs 400 displays and stores the received first video information and first list information.

In addition, each of the plurality of ICSSs 400 transmits the received first video information and first list information to the ICSM 500 and/or at least one ICSC 600 in communication with the plurality of ICSSs 400.

As one example, the first ICSS transmits the received first video information and first list information to a first ICSM and/or a first ICSC in communication with the first ICSS, and the second ICSS transmits the received first video information and first list information to a second ICSM and/or a second ICSC in communication with the second ICSS (S650).

Thereafter, the ICSM 500 receives the first video information and first list information transmitted from the ICSSs 400.

In addition, based on the received first video information and first list information, the ICSM 500 performs the plurality of functions of the ICSM 600 and the management and/or setting function of the ICSS 400, which is a unique function of the ICSM 500 (S660).

Thereafter, the ICSC 600 receives the first video information and first list information transmitted from the ICSS 400.

Based on the received first video information and first list information, the ICSC 600 performs various functions of the ICSC 600 (S670).

In this manner, the ICSSs 400 and the ICSD 700 act as servers and the ICSM 500 and the ICSC 600 act as clients.

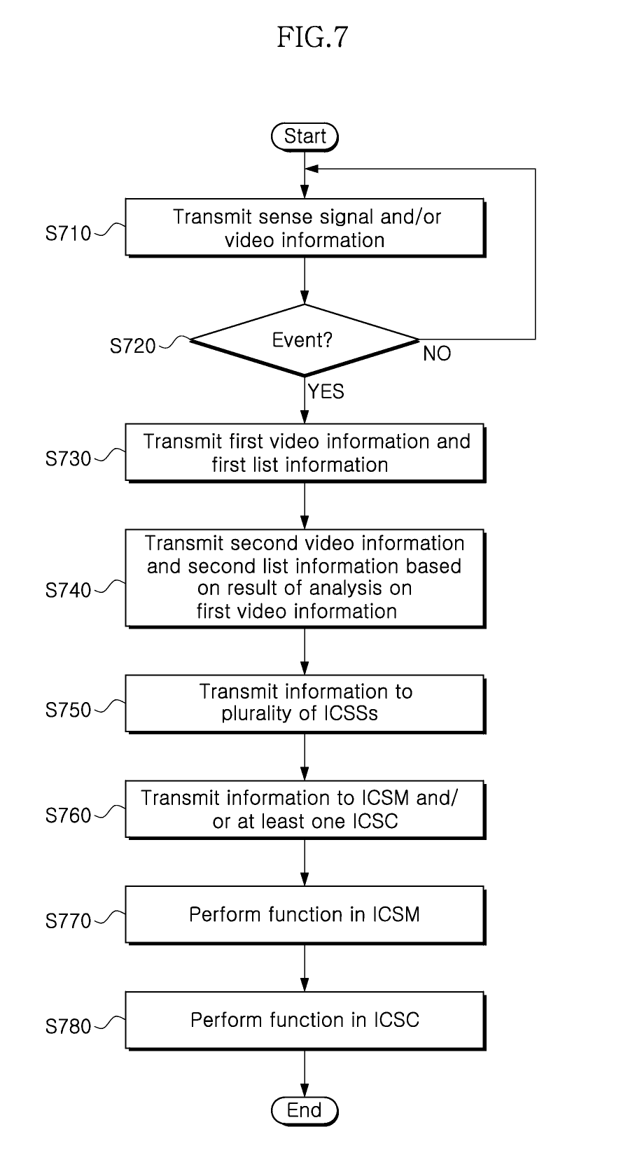

FIG. 7 is a flow chart showing a control method of the intelligent central surveillance server system in accordance with the third embodiment of the present invention.

First, the sensor unit 100 transmits a sensed signal to the digital video transmitter 300 at preset time intervals, random time intervals, or in real time.

The camera unit 200 transmits video information picked in an area (or region) where the camera unit 200 is installed, and an ID of the camera unit 200 to the digital video transmitter 300 (S710).

Thereafter, the digital video transmitter 300 receives the sensed signal from the sensor unit 100 and/or the video information from the camera unit 200.

The digital video transmitter 300 determines whether or not a preset event occurs, based on the received sensed signal and/or video information.

That is, the digital video transmitter 300 determines whether or not a preset event occurs, such as sensing of object's motion, sensing of door ON/OFF and sensing of heat, based on the received sensed signal, such as sensing of object's motion, based on the received video information, and such as camera loss (or video signal disconnection or the like) for the video information transmitted from the camera unit 200 (S720).

Thereafter, if it is determined that the preset event occurs, the digital video transmitter 300 stores first video information on the basis of the point of event occurrence, and transmits it to the ICSD 700 in a wired/wireless manner (S730).

Thereafter, the IVAS 800 receives the first video information and the first list information transmitted from the digital video transmitter 300 in the event occurrence.

The IVAC 800 analyzes the received first video information. Based on a result of the analysis on the first video information, if a preset intelligent video event is sensed, the IVAS 800 stores second video information on the basis of the point of sensing of the intelligent video event, and transmits it to the ICSD 700. Here, the second video information includes trespass, wandering, backward, boundary trespass, object disappearing, object appearing, and camera occlusion (or scene switching/change).

In this manner, when the preset intelligent video event is included in the video information transmitted from the digital video transmitter 300 (or the intelligent video event is sensed), the IVAS 800 transmits the second video information and the second list information to the ICSD 700, thereby providing an additional service according to the video analysis and a result thereof (S740).

Thereafter, the ICSD 700 receives the first video information and first list information transmitted from the digital video transmitter 300 in the occurrence of event.

In addition, the ICSD 700 receives the second video information and second list information transmitted from the IVAS 800 in the sensing of intelligent video event.

The ICSD 700 transmits the received first video information and first list information to the plurality of ICSSs 400 (for example, first ICSS, second ICSS, third ICSS and fourth ICSS).

In addition, the ICSD 700 transmits the received second video information and second list information to the plurality of ICSSs 400 (for example, first ICSS, second ICSS, third ICSS and fourth ICSS) (S750).

Thereafter, each of the plurality of ICSSs 400 receives the first video information and first list information transmitted from the ICSD 700.

In addition, each of the plurality of ICSSs 400 receives the second video information and second list information transmitted from the ICSD 700.

Each of the plurality of ICSSs 400 displays and stores the received first video information, first list information, second video information and second list information.

In addition, each of the plurality of ICSSs 400 transmits the received first video information, first list information, second video information and second list information to the ICSM 500 and/or at least one ICSC 600 in communication with the plurality of ICSSs 400 (S760).

Thereafter, the ICSM 500 receives the first video information, first list information, second video information and second list information transmitted from the ICSSs 400.

Based on the received first video information, first list information, second video information and second list information, the ICSM 500 performs a management and/or setting function of the ICSS 400, a display and storage function of the received first video information, first list information, second video information and second list information, an information management function of a client and/or equipment, a network transfer mode setting function, a confirmation function of video information selected by an operator from the first or second list information (or a playback function of the video information), an event processing function, a real-time video inquiry function through the equipment, a video inquiry function or a speech recording function at the point of event occurrence or the point of intelligent video event sensing through the equipment, a SMS forwarding function and/or an e-mail forwarding function to forward the first list information and/or the second list information to a pre-registered terminal number and/or e-mail address, and a load balance function (or a bypass function) (S770).

Thereafter, the ICSC 600 receives the first video information, first list information, second video information and second list information transmitted from the ICSSs 400.

Based on the received first video information, first list information, second video information and second list information, the ICSC 600 performs the plurality of functions of the ICSM 500 except the management and/or setting function of the ICSS 400.

In this manner, the ICSSs 400, the ICSD 700 and the IVAS 800 act as servers and the ICSM 500 and the ICSC 600 act as clients.

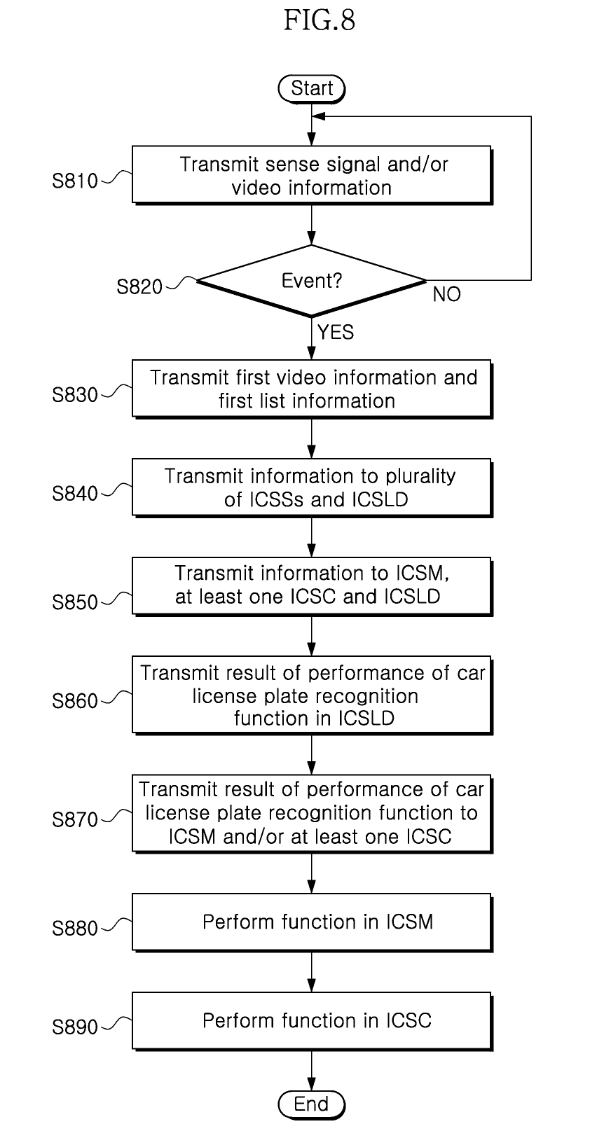

FIG. 8 is a flow chart showing a control method of the intelligent central surveillance server system in accordance with the fourth embodiment of the present invention.

First, the sensor unit 100 transmits a sensed signal to the digital video transmitter 300 at preset time intervals, random time intervals, or in real time.

The camera unit 200 transmits video information picked in an area (or region) where the camera unit 200 is installed, and an ID of the camera unit 200 to the digital video transmitter 300 (S810).

Thereafter, the digital video transmitter 300 receives the sensed signal from the sensor unit 100 and/or the video information from the camera unit 200.

The digital video transmitter 300 determines whether or not a preset event occurs, based on the received sensed signal and/or video information.

That is, the digital video transmitter 300 determines whether or not a preset event occurs, such as sensing of object's motion, sensing of door ON/OFF and sensing of heat, based on the received sensed signal.

In addition, the digital video transmitter 300 determines whether or not a preset event occurs, such as sensing of object's motion, based on the received video information. That is, the digital video transmitter 300 detects a variation of values of pixels included in the received video information and immediately previously received video information to make determination on object's motion, based on the detected variation of values of pixels.

In addition, the digital video transmitter 300 detects a signal related to the presence of malfunction of the camera unit 200, such as camera loss (or video signal disconnection or the like) for the video information transmitted from the camera unit 200 (S820).

Thereafter, if it is determined that the preset event occurs, the digital video transmitter 300 stores first video information on the basis of the point of event occurrence, and transmits it to the ICSD 700 in a wired/wireless manner.

As a result of the determination (or a result of sensing of the object's motion), when the object's motion included in the preset event is sensed, the digital video transmitter 300 stores the first video information on the basis of the point of sensing of the motion (or the point of event occurrence), and transmits it to the ICSD 700 in a wired/wireless manner.

In addition, as a result of sensing of the signal related to the presence of malfunction of the camera unit 200, when the signal related to the presence of malfunction of the camera unit 200 is sensed, the digital video transmitter 300 stores the first video information on the basis of the point of sensing of the signal (or the point of event occurrence), and transmits it to the ICSD 700 in a wired/wireless manner (S830).

Thereafter, the ICSD 700 receives the first video information and first list information transmitted from the digital video transmitter 300 in the occurrence of event.

In addition, the ICSD 700 transmits the received first video information and first list information to the plurality of pre-registered ICSSs 400 (for example, first ICSS, second ICSS, third ICSS and fourth ICSS), and the ICSLD 900 (S840).

Thereafter, each of the plurality of ICSSs 400 receives the first video information and first list information transmitted from the ICSD 700.

Each of the plurality of ICSSs 400 displays and stores the received first video information and first list information.

In addition, each of the plurality of ICSSs 400 transmits the received first video information and first list information to the ICSM 500, at least one ICSC 600 and the ICSLD 900 in communication with the plurality of ICSSs 400 (S850).

Thereafter, the ICSLD 900 receives the first video information and first list information transmitted from the ICSD 700 and/or the plurality of ICSSs 400.

The ICSLD 900 performs a car license plate recognition function based on the received first video information. Here, the car license plate recognition function includes a car license plate recognition function related to any car image contained in the received first video information, a wanted car determination function for the recognized car license plate, etc.

The ICSLD 900 transmits a result of performance of the car license plate license recognition function to the ICSD 700 and/or the plurality of ICSSs 400. Here, the result of performance of the car license plate license recognition function includes information on the recognized car license plate related to any car, information on wanted car determination for the recognized car license plate, etc.

In this manner, the ICSLD 900 can provide a variety of information related to the recognized car license plate by performing the car license plate recognition function based on the received first video information (S860).

Thereafter, the ICSD 700 and/or the plurality of ICSSs 400 receive the result of performance of the car license plate recognition function transmitted from the ICSLD 900. When the ICSD 700 receives the result of performance of the car license plate recognition function transmitted from the ICSLD 900, the ICSD 700 transmits the result of performance of the car license plate recognition function to the plurality of ICCSs 400.

Each of the plurality of ICSSs 400 displays and stores the received result of performance of the car license plate recognition function.

Each of the plurality of ICSSs 400 transmits the received result of performance of the car license plate recognition function to the ICSM 500 and/or at least one ICSC 600 in a wired/wireless manner (S870).

Thereafter, the ICSM 500 receives the first video information and first list information transmitted from the ICSSs 400.

In addition, the ICSM 500 receives the result of performance of the car license plate recognition function transmitted from the ICSSs 400.

Based on the received first video information and first list information, the ICSM 500 performs the plurality of functions of the ICSM 600 and the management and/or setting function of the ICSS 400, which is a unique function of the ICSM 500.

The ICSM 500 displays and/or stores the received result of performance of the car license plate recognition function (S880).

Thereafter, the ICSC 600 receives the first video information and first list information transmitted from the ICSSs 400.

In addition, the ICSC 600 receives the result of performance of the car license plate recognition function transmitted from the ICSSs 400.

The ICSC 600 performs the plurality of functions of the ICSC 600 based on the received first video information and first list information.

The ICSC 600 displays and/or stores the received result of performance of the car license plate recognition function (S890).

In this manner, the ICSSs 400, the ICSD 700 and the ICSLD 900 act as servers and the ICSM 500 and the ICSC 600 act as clients.

As described above, in the embodiments of the present invention, by determining whether or not a preset event occurs based on a sensor sensing signal and/or a motion sensing signal, video information picked in the occurrence of event can be transmitted/received through a server-client system, which results in improved efficiency of the intelligent central surveillance server system.

While the present invention has been particularly shown and described with reference to exemplary embodiments thereof, it will be understood by those skilled in the art that various changes in form and details may be made therein without departing from the spirit and scope of the present invention. The exemplary embodiments are provided for the purpose of illustrating the invention, not in a limitative sense. Thus, it is intended that the present invention covers the modifications and variations of this invention provided they come within the scope of the appended claims and their equivalents.

What is claimed is:

1. An intelligent central surveillance server system comprising:
a sensor unit configured to sense and transmit a sense signal;
a camera unit configured to pick and transmit video information; and
a digital video transmitter configured to determine whether or not a preset event occurs, based on the sense signal and/or the video information, and transmit first video information and first list information related to the first video information on the basis of the point of occurrence of event when the preset event occurs.

2. The intelligent central surveillance server system according to claim 1, wherein the sense signal comprises a contact signal and an ID of the sensor unit.

3. The intelligent central surveillance server system according to claim 1, wherein the digital video transmitter determines whether or not an event of at least one of sensing of object's motion, sensing of door ON/OFF and sensing of heat, based on the sense signal, senses the object's motion based on the video information, or determines video signal disconnection for the video information transmitted from the camera unit.

4. The intelligent central surveillance server system according to claim 1, wherein the first video information includes the preset number of previous video information on the basis of the point of event occurrence, current video information, and the preset different number of posterior video information, and the first list information includes a representative still cut related to the first video information, an ID of the camera unit picked the first video information, and information on the point of event occurrence.

5. The intelligent central surveillance server system according to claim 1, further comprising:
an intelligent central surveillance server (ICSS) configured to receive, display and store the first video information and first list information transmitted from the digital video transmitter, and transmit the first video information and first list information to an intelligent central surveillance management (ICSM) and/or at least one intelligent central surveillance client (ICSC) in communicative connection with the ICSS;
the ICSC configured to perform at least one of a display and storage function of the first video information and/or first list information, an information management function of a client and/or equipment, a network transfer mode setting function, a confirmation function of video information selected by an operator from the first list information, an event processing function, a real-time video inquiry function through the equipment, a video inquiry function or a speech recording function at the point of event occurrence through the equipment, a SMS forwarding function and/or an e-mail forwarding function to forward the first list information to a pre-registered terminal number and/or an e-mail address, and a load balance function, based on the first video information and first list information; and
the ICSM configured to perform at least one of the plurality of functions performed by the ICSC and a management and/or setting function of the ICSS, based on the first video information and first list information.

6. The intelligent central surveillance server system according to claim 1, further comprising:
an intelligent central surveillance daemon (ICSD) configured to receive the first video information and first list information transmitted from the digital video transmitter and transmit the first video information and first list information to a plurality of intelligent central surveillance servers (ICSSs) in communicative connection with the ICSD; and
the ICSSs configured to receive, display and store the first video information and first list information transmitted from the digital video transmitter, and transmit the first video information and first list information to an intelligent central surveillance management (ICSM) and/or at least one intelligent central surveillance client (ICSC) in communicative connection with the ICSSs.

7. The intelligent central surveillance server system according to claim 1, further comprising:
an intelligent video analog system (IVAS) configured to receive the first video information and first list information transmitted from the digital video transmitter, and, when an intelligent video event is sensed based on the received first video information, transmit second video information and second list information related to the second video information to an intelligent central surveillance daemon (ICSD) on the basis of the point of occurrence of the intelligent video event;
the ICSD configured to receive the first video information and first list information transmitted from the digital video transmitter and the second video information and second list information transmitted from the IVAS and transmit the first video information, first list information, second video information and second list information to a plurality of intelligent central surveillance servers (ICSSs) in communicative connection with the ICSD; and
the ICSSs configured to receive, display and store at least one of the first video information, first list information, second video information and second list information, and transmit the first video information, first list information, second video information and second list information to an intelligent central surveillance management (ICSM) and/or at least one intelligent central surveillance client (ICSC) in communicative connection with the ICSSs.

8. The intelligent central surveillance server system according to claim 7, wherein the intelligent video event includes at least one of trespass, wandering, backward, boundary trespass, object disappearing, object appearing, and camera occlusion.

9. The intelligent central surveillance server system according to claim 1, further comprising:
an intelligent central surveillance daemon (ICSD) configured to receive the first video information and first list information transmitted from the digital video transmitter and transmit the first video information and first list information to an intelligent central surveillance license plate daemon (ICSLD) and a plurality of intelligent central surveillance servers (ICSSs) in communicative connection with the ICSD;
the ICSSs configured to receive, display and store the first video information and first list information transmitted from the ICSD, and transmit the first video information and first list information to an intelligent central surveillance management (ICSM), at least one intelligent central surveillance client (ICSC) and the ICSLD in communicative connection with the ICSSs; and
the ICSLD configured to perform a car license plate recognition function based on the first video information transmitted from the ICSD and the plurality of ICSSs, and transmit a result of the performance of car license plate recognition function to the ICSD and/or the plurality of ICSSs.

10. The intelligent central surveillance server system according to claim 9, wherein the result of the performance of car license plate recognition function includes information on recognized car license plate related to any car contained in the first video information, and information on wanted car determination for the recognized car license plate.

11. A control method of an intelligent central surveillance server system including a digital video transmitter configured to determine whether or not a preset event occurs, an intelligent central surveillance server (ICSS) acting as a server, an intelligent central surveillance management (ICSM) and an intelligent central surveillance client (ICSC) acting as clients, comprising the steps of:
receiving a sense signal which is sensed by and transmitted from a sensor unit, through the digital video transmitter;
receiving video information which is transmitted from a camera unit, through the digital video transmitter;
determining whether or not the preset event occurs, based on the received sense signal and/or video information, through the digital video transmitter; and
when it is determined that the preset event occurs, transmitting first video information and first list information related to the first video information on the basis of the point of occurrence of event, through the digital video transmitter.

12. The control method according to claim 11, wherein the sense signal includes a contact signal and an ID of the sensor unit.

13. The intelligent central surveillance server system according to claim 11, wherein the step of determining whether or not the preset event occurs includes determining whether or not an event of at least one of sensing of object's motion, sensing of door ON/OFF and sensing of heat, based on the sense signal, sensing the object's motion based on the video information, or determining video signal disconnection for the video information transmitted from the camera unit.

14. The control method according to claim 11, wherein the first video information comprises the preset number of previous video information on the basis of the point of event occurrence, current video information, and the preset different number of posterior video information, and the first list information comprises a representative still cut related to the first video information, an ID of the camera unit picked the first video information, and information on the point of event occurrence.

15. The control method according to claim 11, wherein, when it is determined that the preset event occurs, the control method further comprises the steps of:
displaying and storing the first video information and first list information transmitted from the digital video transmitter and transmitting the first video information and first list information to the ICSM and/or at least one intelligent central surveillance client (ICSC) in communicative connection with the ICSS, through the ICSS;
performing at least one of a display and storage function of the first video information and/or first list information, an information management function of a client and/or equipment, a network transfer mode setting function, a confirmation function of video information selected by an operator from the first list information, an event processing function, a real-time video inquiry function through the equipment, a video inquiry function or a speech recording function at the point of event occurrence through the equipment, a SMS forwarding function and/or an e-mail forwarding function to forward the first list information to a pre-registered terminal number and/or an e-mail address, and a load balance function, based on the first video information and first list information, through the ICSC; and
performing at least one of the plurality of functions performed by the ICSC and a management and/or setting function of the ICSS, based on the first video information and first list information, through the ICSM.

16. The control method according to claim 11, wherein, when it is determined that the present event occurs, the control method further comprises the steps of:
receiving the first video information and first list information transmitted from the digital video transmitter, through an intelligent central surveillance daemon (ICSD);
transmitting the received first video information and first list information to a plurality of intelligent central surveillance servers (ICSSs) in communicative connection with the ICSD, through the ICSD; and
displaying and storing the first video information and first list information transmitted from the digital video transmitter, and transmitting the first video information and first list information to the ICSM and/or at least one intelligent central surveillance client (ICSC) in communicative connection with the ICSSs, through the ICSSs.

17. The control method according to claim 11, wherein, when it is determined that the present event occurs, the control method further comprises the steps of:
receiving the first video information and first list information transmitted from the digital video transmitter, through an intelligent video analog system (IVAS);
when a preset intelligent video event is sensed based on the received first video information, transmitting second video information and second list information related to the second video information to an intelligent central surveillance daemon (ICSD) on the basis of the point of occurrence of the intelligent video event, through the IVAS; and
receiving the first video information and first list information transmitted from the digital video transmitter and the second video information and second list information transmitted from the IVAS and transmitting the first video information, first list information, second video information and second list information to a plurality of intelligent central surveillance servers (ICSSs) in communicative connection with the ICSD, through the ICSD.

18. The control method according to claim 17, wherein the intelligent video event includes at least one of trespass, wandering, backward, boundary trespass, object disappearing, object appearing, and camera occlusion.

19. The control method according to claim 11, wherein, when it is determined that the present event occurs, the control method further comprises the steps of:
receiving the first video information and first list information transmitted from the digital video transmitter, through an intelligent central surveillance daemon (ICSD);
transmitting the received first video information and first list information to an intelligent central surveillance license plate daemon (ICSLD) and a plurality of intelligent central surveillance servers (ICSSs) in communicative connection with the ICSD, through the ICSD;
receiving the first video information and first list information transmitted from the ICSD and/or the plurality of ICSSs, through the ICSLD;
performing a car license plate recognition function based on the received first video information, through the ICSLD; and
transmitting a result of the performance of car license plate recognition function to the ICSD and/or the plurality of ICSSs, through the ICSLD.

20. The control method according to claim 19, wherein the result of the performance of car license plate recognition function comprises information on recognized car license plate related to any car contained in the first video information, and information on wanted car determination for the recognized car license plate.
